(19) United States
(12) Patent Application Publication
(10) Pub. No.: US 2017/0157990 A1
(43) Pub. Date: Jun. 8, 2017

(54) PNEUMATIC TIRE

(71) Applicant: The Goodyear Tire & Rubber Company, Akron, OH (US)

(72) Inventors: Lionel Jean-Marie BORTOLET, Gorcy (FR); Phuoc Thuan LE, Attert (BE)

(21) Appl. No.: 14/961,930

(22) Filed: Dec. 8, 2015

(51) Int. Cl. B60C 11/13

(52) U.S. Cl. CPC B60C 11/1307; B60C 2011/1338

(57) ABSTRACT

Disclosed herein is a pneumatic tire having a tread. The tread has a plurality of tread elements separated by at least one groove, the tread elements having a depth as determined from an initial tread surface and the base of the at least one groove. The tread has at least one stone ejector. The stone ejector is positioned at the intersection of a first and second groove.

### FIELD OF THE INVENTION

The present invention relates to a pneumatic tire. More particularly, the present invention is directed to a tire tread having a stone ejector.

### BACKGROUND OF THE INVENTION

One problem encountered in the use of pneumatic tires, particularly for larger tires such as those used on bus or truck tires, is the entrapment of stones or debris in the tire tread. If a stone is trapped in the tread groove, it may result in the damage of the groove due to the repeated impact of the stone or debris against the groove sidewall. It is thus desired to have an improved tread design having an improved stone ejector.

### SUMMARY OF THE INVENTION

Disclosed herein is a pneumatic tire having a tread. The tread has a plurality of tread elements separated by at least one groove, the tread elements having a depth as determined from an initial tread surface and the base of the at least one groove. The tread has at least one stone ejector.

### DEFINITIONS

The following definitions are controlling for the disclosed invention.

“Axial” and “axially” are used herein to refer to lines or directions that are parallel to the axis of rotation of the tire.

“Centerplane (CP)” means the plane perpendicular to the tire's axis of rotation and passing through the center of its tread.

“Circumferential” means lines or directions extending along the perimeter of the surface of the annular tire parallel to the Centerplane CP and perpendicular to the axial direction.

“Radial” and “radially” are used to mean directions radially toward or away from the axis of rotation of the tire.

### BRIEF DESCRIPTION OF THE DRAWINGS

The invention will be described by way of example and with reference to the accompanying drawings in which:

FIG. 1 is one plan view of a tire tread;

FIG. 2 is a plan view of a stone ejector in a tread;

FIG. 3 is close up of FIG. 1 showing the stone ejector; and

FIG. 4 is a side view of the stone ejector.

### DETAILED DESCRIPTION OF THE INVENTION

The following language is of the best presently contemplated mode or modes of carrying out the invention. This description is made for the purpose of illustrating the general principles of the invention and should not be taken in a limiting sense. The scope of the invention is best determined by reference to the appended claims.

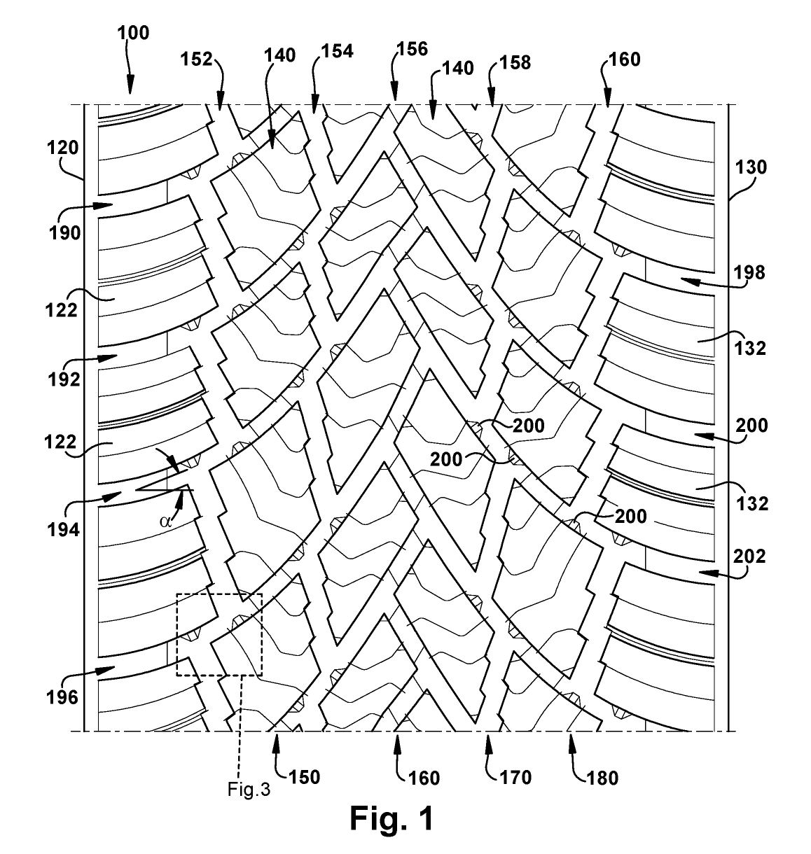

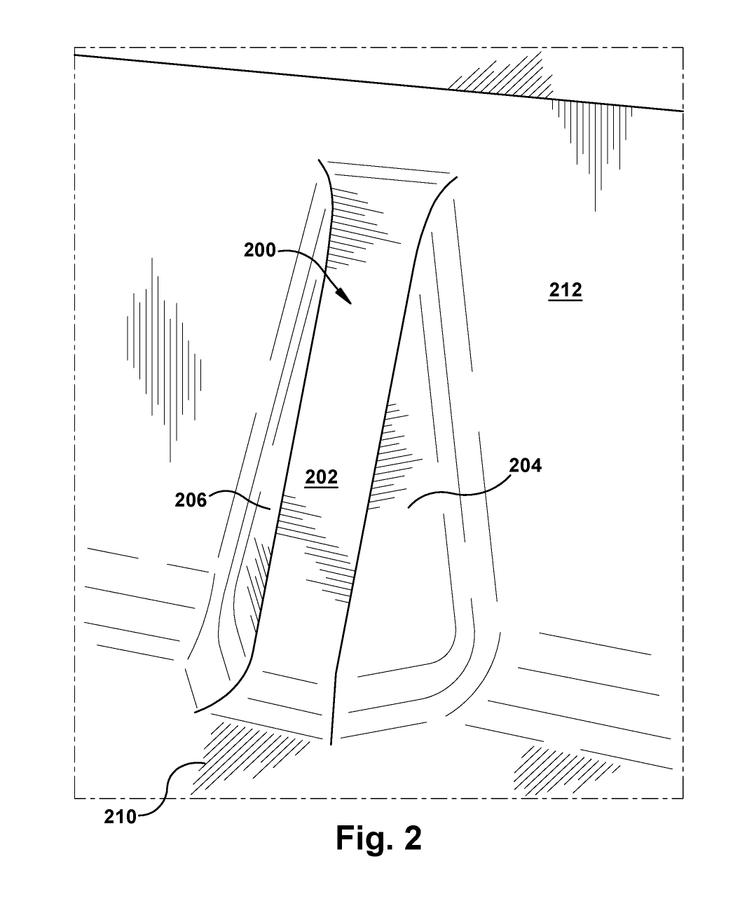

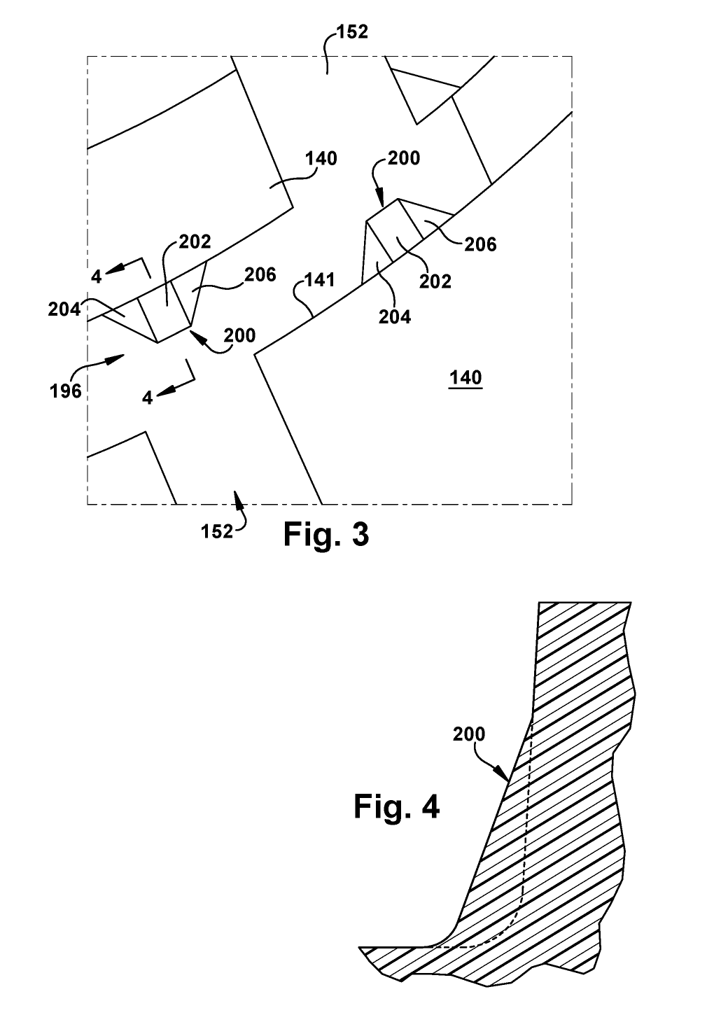

FIG. 1 illustrates a flat view of a portion of a tire tread 100. The tire tread may be symmetrical about a tread centerline or asymmetrical as shown. The tread 100 has a first lateral edge 120 and a second lateral edge 130. At each lateral edge 120,130 there are a plurality of circumferentially aligned shoulder treads blocks 122,132. Located between the shoulder tread blocks 122,132 are a plurality of tread blocks 140. As shown, the plurality of tread blocks 140 may be arranged in circumferential rows 150, 160, 170, 180, although not required. The tread blocks are separated from each other by circumferential grooves 152,154,156,158,160, that may be straight, saw toothed or zigzaged in shape. There may also be one or more lateral grooves 190,192,194,196198,200,202 that separate the tread blocks from each other. The lateral grooves preferably form an angle α with respect to the axial direction in the range of 20° to 90°, or 30° to 45°.

Each tread block has an overall rectangular or square shape, which may be asymmetrical with serrated edges as shown, or may be symmetrical with smooth edges. Each tread block has at least edge that has at least one stone ejectors 200 projecting therefrom.

The stone ejector 200 is preferably positioned along a tread block wall 141 located at the intersection of a first and second groove, for example, groove 152, and groove 196. The stone ejector 200 is positioned along a tread block wall 141 opposite groove 152. The stone ejector 200 acts as a shovel to move the stone or debris out of the groove 196 towards the opposite groove 152. Preferably, the width w1 of the opposite groove 152 is wider than the lateral groove 196 width w2. Thus the stone ejector 200 shovels the stone into a wider groove to facilitate ejection from the tread. Preferably, the width w1 is in the range of 20-50% wider than the width w2. As shown, the stone ejector has three sides 202,204,206 forming a main ramp 202 that extends from the bottom of the groove 210 to the upper portion of the side of the groove. The stone ejector is shaped like a nose that extends from the groove sidewall (face) 212. The main ramp 202 forms an angle with the groove bottom in the range of about 20-80 degrees, more preferably in the range of 30-60 degrees.

While the stone ejector is illustrated in the context of one particular tread configuration, the stone ejector may be used as an element in other tread configurations and the use thereof in accordance with the present invention is not limited to the particular tread configuration illustrated.

What is claimed is:

1. A pneumatic tire, the tire comprising a tread, the tread having a plurality of tread elements separated by at least one groove, the tread elements having a depth as determined from an initial tread surface and the base of the at least one groove, wherein, the tread element has a sidewall, wherein a tread ejector has a first end positioned on the sidewall.

2. The tire of claim 1 wherein the stone ejector has at least one inclined wall which extends from the groove bottom to the tread element sidewall.

3. The tire of claim 1 wherein the inclined wall of the stone ejector is angled in the range of 10° to 60° relative to the groove bottom surface.

3. The tire of claim 1 wherein the stone ejector is positioned at the intersection of the first groove and a second groove.
